(19) United States
(12) Patent Application Publication
(10) Pub. No.: US 2019/0369924 A1
(43) Pub. Date: Dec. 5, 2019

(54) Printing Assistant System and Chatbot Device

(71) Applicant: Kyocera Document Solutions Inc., Osaka (JP)

(72) Inventor: Yosuke Oka, Osaka (JP)

(73) Assignee: Kyocera Document Solutions Inc.

(21) Appl. No.: 16/419,010

(22) Filed: May 22, 2019

(30) Foreign Application Priority Data
May 29, 2018 (JP) 2018-102004

(51) Int. Cl. G06F 3/12; H04L 12/58

(52) U.S. Cl. CPC G06F 3/1204; G06F 3/1205; G06F 3/1253; H04L 51/02; G06F 3/1206

(57) ABSTRACT

A printing assistant system includes a server device and a chatbot device. The chatbot device: receives the answer message from the server device, creates a different question message that inquires of the user of the terminal device about a parameter to be set to a different settable item corresponding to contents of the answer message, and posts the created question message to the server device, repeats posting of a plurality of different question messages until receiving a plurality of answer messages identifying parameters to be set to all the plurality of settable items from the server device, and sets parameters to all the plurality of settable items based on the plurality of answer messages received from the server device. The chatbot device creates a print job that prints the file in accordance with the parameters set to all the plurality of settable items.

### INCORPORATION BY REFERENCE

This application is based upon, and claims the benefit of priority from, corresponding Japanese Patent Application No. 2018-102004 filed in the Japan Patent Office on May 29, 2018, the entire contents of which are incorporated herein by reference.

### BACKGROUND

Unless otherwise indicated herein, the description in this section is not prior art to the claims in this application and is not admitted to be prior art by inclusion in this section.

It has been known that an automatic posting system (what is called, a chatbot) automatically posts a message to a chat system as one of a Social Networking Service (SNS) system.

### SUMMARY

A printing assistant system according to one aspect of the disclosure includes a server device and a chatbot device. The server device is connected to a network. The server device provides a chat system and includes a first control circuit. The chatbot device is connected to the network. The chatbot device includes a second control circuit that automatically posts a message to the chat system. The first control circuit of the server device operates as a file posting unit and a file transferring unit. The file posting unit uploads files posted via the network to the chat system. The file transferring unit transfers a file as a print target among the files uploaded to the chat system and image-forming-apparatus identification information to the chatbot device. The image-forming-apparatus identification information identifies an image forming apparatus that prints the file. The file as the print target is selected from a terminal device via the network, and the image-forming-apparatus identification information is selected from the terminal device via the network. The second control circuit of the chatbot device operates as a file obtainer and a print setting posting unit. The file obtainer receives the file and the image-forming-apparatus identification information from the server device. The print setting posting unit creates a question message that inquires of a user of the terminal device about a parameter to be set to one settable item among a plurality of settable items and posts the question message to the server device. The plurality of settable items includes items settable as print setting by the image forming apparatus identified with the image-forming-apparatus identification information. The first control circuit of the server device operates as a printing chat management unit that receives the question message posted by the chatbot device to upload the question message to the chat system, receives an answer message identifying the parameter to be set to the one settable item posted by the terminal device to upload the answer message to the chat system, and transfers the uploaded answer message to the chatbot device. The print setting posting unit of the chatbot device: receives the answer message from the server device, creates a different question message that inquires of the user of the terminal device about a parameter to be set to a different settable item corresponding to contents of the received answer message, and posts the created question message to the server device, repeats posting of a plurality of different question messages until receiving a plurality of answer messages identifying parameters to be set to all the plurality of settable items from the server device, and sets parameters to all the plurality of settable items based on the plurality of answer messages received from the server device. The second control circuit of the chatbot device operates as a job execution unit that creates a print job that prints the file in accordance with the parameters set to all the plurality of settable items and transmits the print job to the image forming apparatus via the network.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 schematically illustrates a printing assistant system according to one embodiment of the disclosure;

FIG. 2 illustrates a hardware configuration of an image forming apparatus according to the one embodiment;

FIG. 3 illustrates a hardware configuration of a chatbot device according to the one embodiment;

FIG. 4 illustrates a hardware configuration of a server device according to the one embodiment;

FIG. 5 illustrates a hardware configuration of a terminal device according to the one embodiment;

FIG. 6 illustrates a functional configuration of the printing assistant system according to the one embodiment;

FIG. 7 illustrates a first behavior sequence of the printing assistant system according to the one embodiment;

FIG. 8 illustrates an exemplary chat screen;

FIG. 9 illustrates another exemplary chat screen;

FIG. 10 illustrates an exemplary data configuration in a printer table;

FIG. 11 illustrates an exemplary data configuration in a settable item table;

FIG. 12 illustrates a second behavior sequence of the printing assistant system according to the one embodiment;

FIG. 13 illustrates an exemplary data configuration in a favorite table;

FIG. 14 illustrates an exemplary data configuration in a dictionary table; and

FIG. 15 illustrates a third behavior sequence of the printing assistant system according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure by referring to the drawings.

### 1. Outline of Printing Assistant System

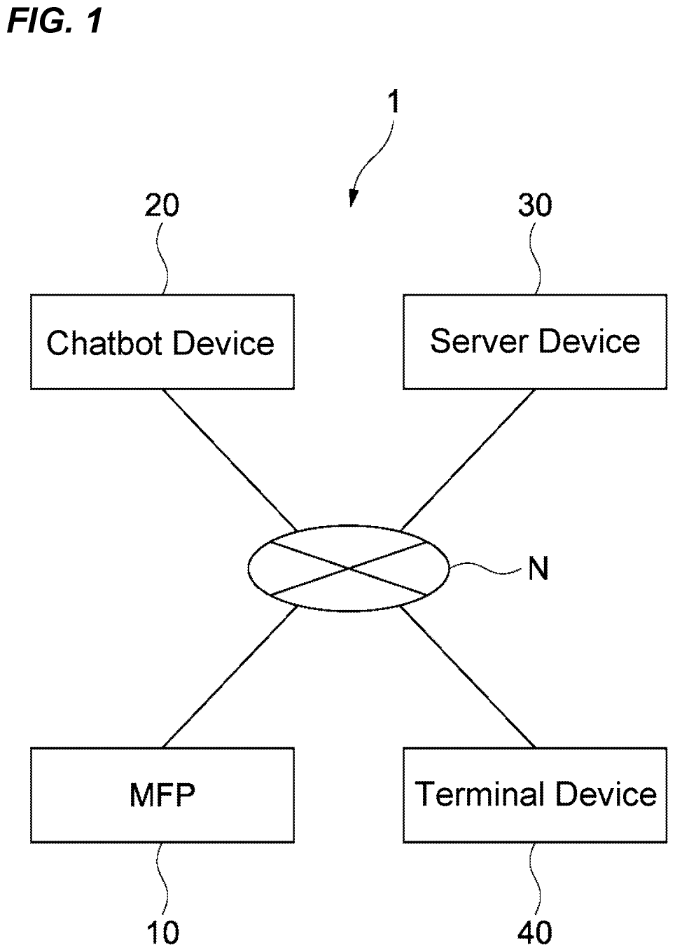

FIG. 1 schematically illustrates a printing assistant system according to one embodiment of the disclosure.

A printing assistant system 1 includes an image forming apparatus (Multifunction Peripheral, hereinafter simply referred to as an MFP) 10, a chatbot device 20, a server device 30, and a terminal device 40. The MFP 10, the chatbot device 20, the server device 30, and the terminal device 40 are mutually connected via a network N including the Internet.

The server device 30 provides a chat system as one of an SNS system. The server device 30 uploads a file posted from a terminal device (it may be the terminal device 40 or another terminal device) via the network N to the chat system.

The terminal device 40, which is, for example, a smart phone, a tablet computer, a personal computer, and a wearable computer, is used by an end user (hereinafter simply referred to as a user). The user browses the chat system using the terminal device 40 to select a file (already uploaded to the chat system) as a print target and the MFP 10 that prints the file.

The chatbot device 20 automatically posts a message to the chat system, which is provided by the server device 30. The chatbot device 20 chats with the user of the terminal device 40 to set a parameter to be set to a print settable item (for example, color and duplex) when the MFP 10 prints the file. The chatbot device 20 creates a print job that prints this file in accordance with the set parameter to transmit the print job to the MFP 10 via the network N.

The MFP 10 receives the print job from the chatbot device 20 via the network N. The MFP 10 prints the file included in the print job in accordance with the parameter set to the print settable item included in the print job.

### 2. Hardware Configuration of Image Forming Apparatus

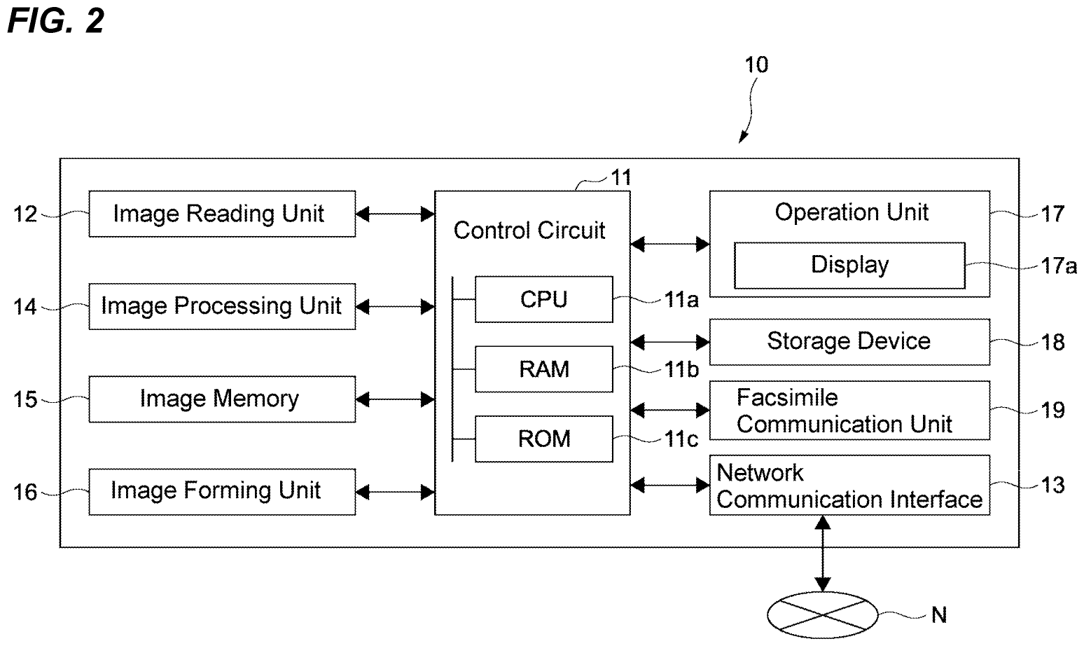

FIG. 2 illustrates a hardware configuration of the image forming apparatus.

The MFP 10 includes a control circuit 11. The control circuit 11, which is configured from a Central Processing Unit (CPU) 11a as a processor, a Random Access Memory (RAM) 11b, a Read Only Memory (ROM) 11c as a memory, a dedicated hardware circuit, and the like, manages an overall operation control of the MFP 10.

The control circuit 11 is connected to an image reading unit 12, an image processing unit 14, an image memory 15, an image forming unit 16, an operation unit 17 including a display 17a, a storage device 18, a facsimile communication unit 19, a network communication interface 13, and the like. The control circuit 11 performs operation control of the above-described connected respective units and transmitting and receiving of a signal or data between the respective units.

### 3. Hardware Configuration of Chatbot Device

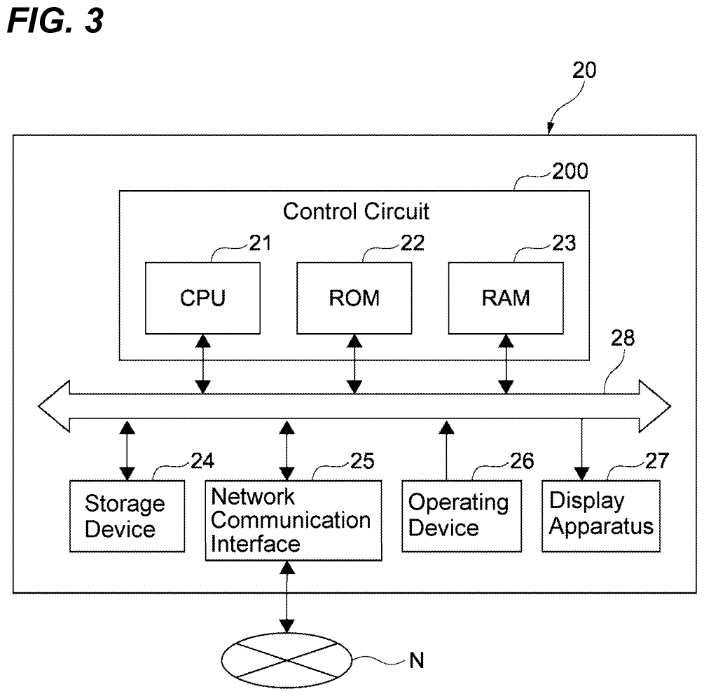

FIG. 3 illustrates a hardware configuration of the chatbot device.

The chatbot device 20 includes a CPU 21, a ROM 22, a RAM 23, a storage device 24, a network communication interface 25, an operating device 26, a display apparatus 27, and a bus 28 that mutually connects them.

The CPU 21, the ROM 22, and the RAM 23 constitute a control circuit 200 (a second control circuit). The CPU 21 loads an information processing program stored in the ROM 22 to the RAM 23 to execute it. The ROM 22 fixedly stores a program, data, and the like, which are executed by the CPU 21. The ROM 22 is an exemplary non-transitory computer-readable recording medium.

The storage device 24 is a large-capacity recording medium such as a Hard Disk Drive (HDD) and a Solid State Drive (SSD).

The network communication interface 25 is an interface to connect to the network N.

The operating device 26 includes a touch panel, a keyboard, a computer mouse, various switches, and the like.

The display apparatus 27 includes a LCD, an organic EL display, and the like. The display apparatus 27 performs arithmetic processing based on information received from the CPU 21 to display a generated image signal on a screen. The display apparatus 27 may be an external display apparatus.

### 4. Hardware Configuration of Server Device

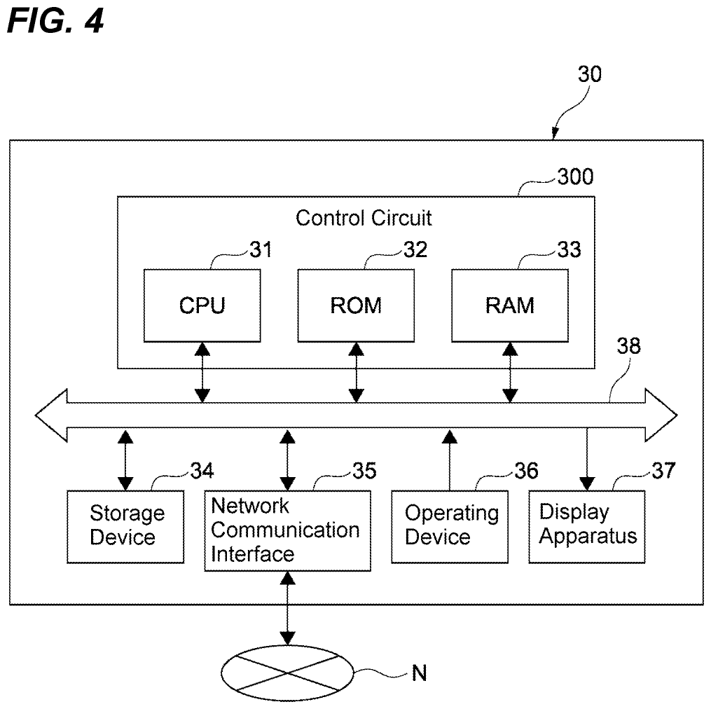

FIG. 4 illustrates a hardware configuration of the server device.

The hardware configuration of the server device 30 is similar to the hardware configuration of the chatbot device 20. The server device 30 includes a CPU 31, a ROM 32, a RAM 33, a storage device 34, a network communication interface 35, an operating device 36, a display apparatus 37, and a bus 38 that mutually connects them. The CPU 31, the ROM 32, and the RAM 33 constitute a control circuit 300 (a first control circuit).

### 5. Hardware Configuration of Terminal Device

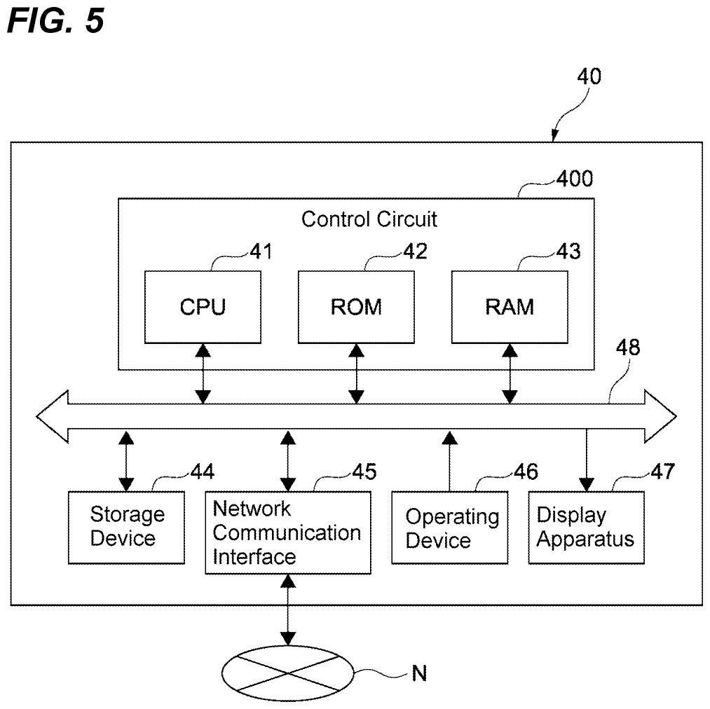

FIG. 5 illustrates a hardware configuration of the terminal device.

The hardware configuration of the terminal device 40 is similar to the hardware configuration of the server device 30. The terminal device 40 includes a CPU 41, a ROM 42, a RAM 43, a storage device 44, a network communication interface 45, an operating device 46, a display apparatus 47, and a bus 48 that mutually connects them. The CPU 41, the ROM 42, and the RAM 43 constitute a control circuit 400.

### 6. Functional Configuration of Printing Assistant System

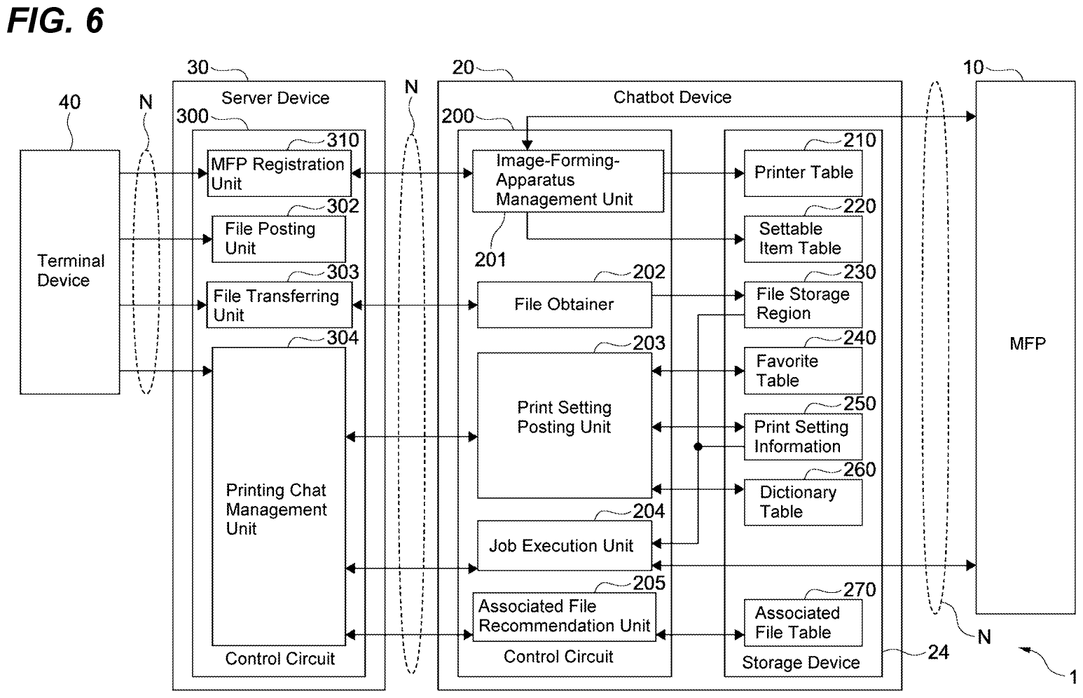

FIG. 6 illustrates a functional configuration of the printing assistant system.

In the control circuit 200 of the chatbot device 20, the CPU 21 loads one or a plurality of information processing programs stored in the ROM 22 to the RAM 23 to execute them, thus behaving as an image-forming-apparatus management unit 201, a file obtainer 202, a print setting posting unit 203, a job execution unit 204, and an associated file recommendation unit 205.

In the control circuit 300 of the server device 30, the CPU 31 loads one or a plurality of information processing programs stored in the ROM 32 to the RAM 33 to execute them, thus behaving as an image-forming-apparatus registration unit 301, a file posting unit 302, a file transferring unit 303, and a printing chat management unit 304.

The image-forming-apparatus registration unit 301 of the server device 30 uploads MFP identification information posted from the terminal device 40 via the network N to the chat system to transfer the MFP identification information to the chatbot device 20. The MFP identification information is an example of image-forming-apparatus identification information.

The image-forming-apparatus management unit 201 of the chatbot device 20 inquires of the MFP 10 via the network N about a plurality of settable items and a plurality of settable parameters of the MFP 10 identified with the MFP identification information received from the server device 30 via the network N, thus managing the plurality of settable items and the plurality of settable parameters obtained from the MFP 10.

The file posting unit 302 of the server device 30 receives the file posted from the terminal device 40 via the network N to upload the file to the chat system.

The file transferring unit 303 of the server device 30 transfers the file as the print target among the files uploaded to the chat system, which is selected from the terminal device 40 via the network N, and the MFP identification information as the information that identifies the MFP 10 that prints the file, which is selected from the terminal device 40 via the network N, to the chatbot device 20.

The file obtainer 202 of the chatbot device 20 receives at least the file as the print target and the MFP identification information that identifies the MFP 10 that prints the file from the server device 30 via the network N.

The printing chat management unit 304 of the server device 30 receives the message posted by the chatbot device 20 to upload it to the chat system. The printing chat management unit 304 receives the message posted by the terminal device 40 to upload it to the chat system, thus transferring the message posted by the terminal device 40 to the chatbot device 20.

The print setting posting unit 203 of the chatbot device 20 creates a question message that inquires of the user of the terminal device 40 about the parameter to be set to the settable item as an item settable by the MFP 10 as print setting, thus posting the question message to the server device 30. The print setting posting unit 203 receives an answer message from the server device 30 and creates a different question message that inquires of the user of the terminal device 40 about a parameter to be set to a different settable item corresponding to contents of the received answer message, thus posting the different question message to the server device 30. The print setting posting unit 203 repeats posting of a plurality of different question messages until receiving a plurality of answer messages that identify parameters to be set to all the plurality of settable items from the server device 30. The print setting posting unit 203 sets the parameters to all the plurality of settable items based on the plurality of answer messages received from the server device 30.

The job execution unit 204 of the chatbot device 20 creates the print job that prints the file in accordance with the parameters set to all the plurality of settable items to transmit the print job to the MFP 10 via the network N.

The associated file recommendation unit 205 of the chatbot device 20 stores the file as the print target and terminal device identification information that identifies the terminal device 40 that has selected the file as the print target with being associated with one another in an associated file table 270 of the storage device 24. The associated file recommendation unit 205 creates a recommendation message that recommends another file selected by another terminal device that has selected the file as the print target in the past to the user of the terminal device 40, thus posting the recommendation message to the server device 30.

### 7. Behavior Sequence of Printing Assistant System

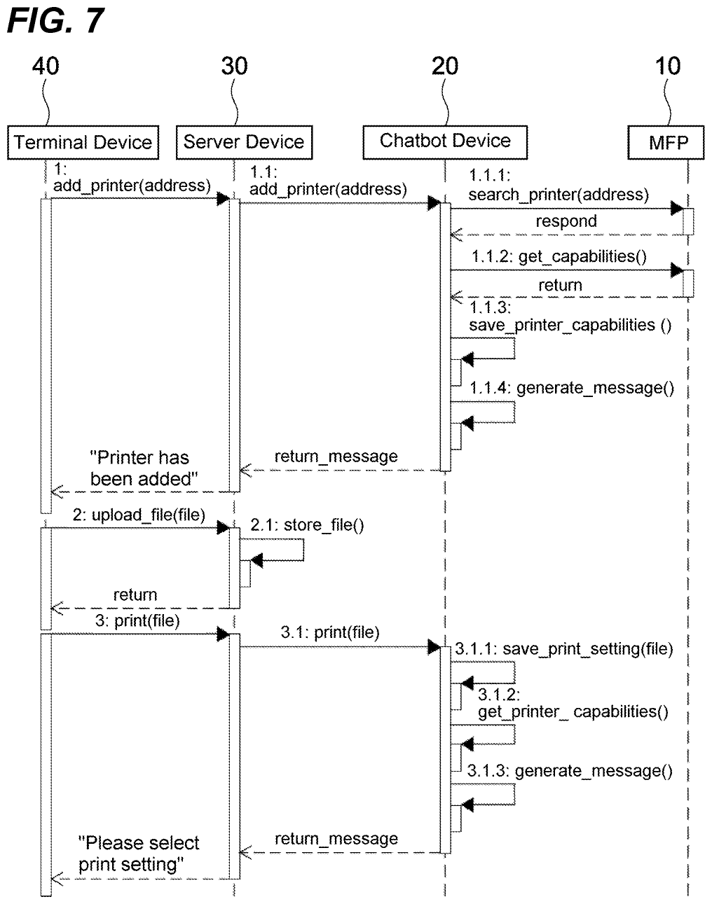

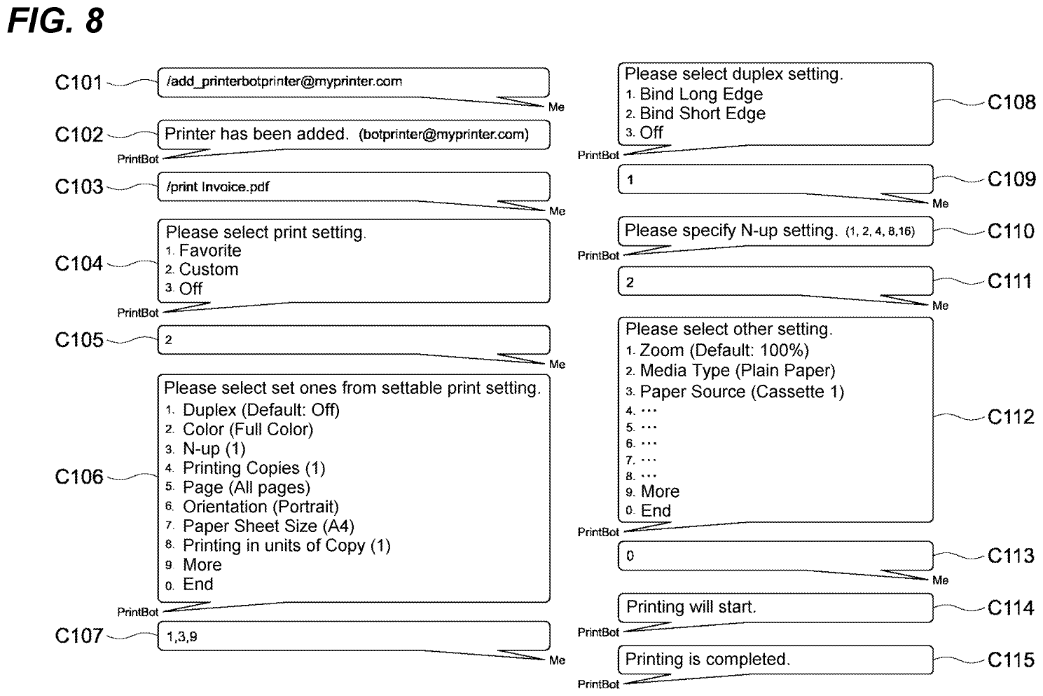

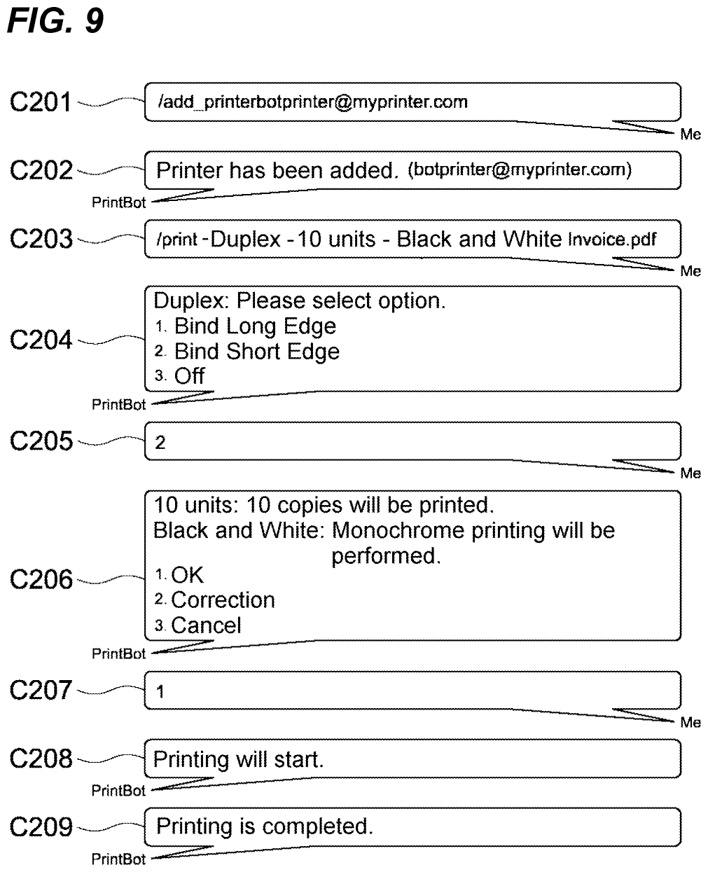

FIG. 7 illustrates a first behavior sequence of the printing assistant system. FIG. 8 illustrates an exemplary chat screen uploaded to the chat system to be displayed on the terminal device 40. FIG. 9 illustrates another exemplary chat screen uploaded to the chat system to be displayed on the terminal device 40.

(1) MFP Registration Behavior Sequence

The user browses the chat system using the terminal device 40 to post the MFP 10 that executes printing (will execute printing now, or will possibly execute printing in the future) to the chat system via the network N. Specifically, the user posts the MFP identification information as identification information of the MFP 10 to a specific channel of the chat system using the terminal device 40. “The identification information of the MFP 10” may be, for example, an e-mail address of the MFP 10.

The image-forming-apparatus registration unit 301 of the server device 30 receives the MFP identification information (e-mail address) posted from the terminal device 40 via the network N (Step 1). The image-forming-apparatus registration unit 301 uploads the posted MFP identification information (e-mail address) to the chat system. This displays the posting of the MFP identification information (e-mail address) uploaded to the chat system on the terminal device 40 (C101 in FIG. 8 and C201 in FIG. 9). The image-forming-apparatus registration unit 301 transfers the MFP identification information (e-mail address) to the chatbot device 20 via the network N (Step 1.1).

The image-forming-apparatus registration unit 301 may register, for example, the channel different depending on the MFP 10 identified with the MFP identification information posted via the network N in the chat system. In the following description, a description will be given assuming that the channel is thus differentiated depending on the MFP 10. Alternatively, the image-forming-apparatus registration unit 301 need not differentiate the channel depending on the MFP 10.

The image-forming-apparatus management unit 201 of the chatbot device 20 receives the MFP identification information (e-mail address) from the server device 30 via the network N. The image-forming-apparatus management unit 201 searches the MFP 10 identified with the MFP identification information (e-mail address) from the network N (Step 1.1.1). The image-forming-apparatus management unit 201 receives a response from the corresponding MFP 10 via the network N. The response includes, for example, a model name, a serial number, an IP address, the e-mail address, a MAC address of the MFP 10. The image-forming-apparatus management unit 201 registers such information included in the received response in a printer table 210 stored in the storage device 24.

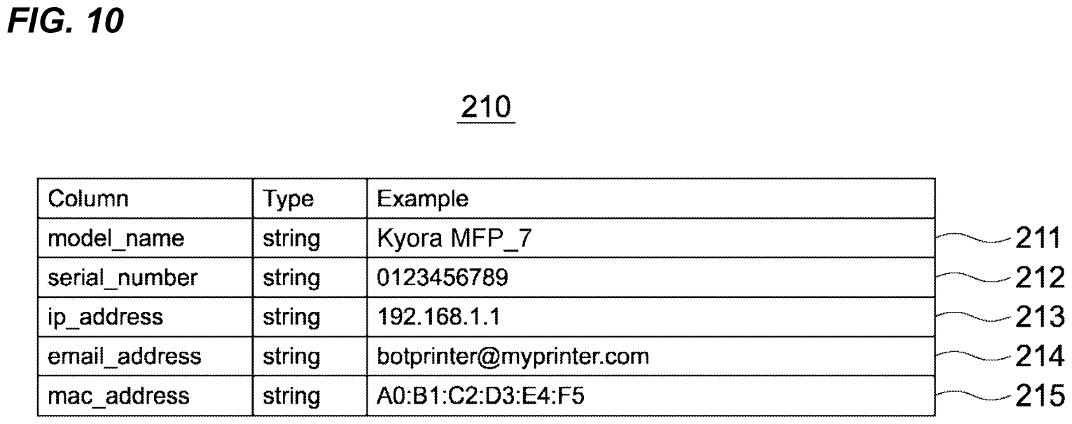

FIG. 10 illustrates an exemplary data configuration of the printer table.

The printer table 210 registers a model name 211, a serial number 212, an IP address 213, an e-mail address 214, and a MAC address 215 with being associated with one another for one MFP 10.

The image-forming-apparatus management unit 201 of the chatbot device 20 inquires of the MFP 10, whose response has been received, via the network N about the settable item and the settable parameter (Step 1.1.2). The image-forming-apparatus management unit 201 receives the response (settable item and settable parameter) from the MFP 10 via the network N. The response includes, for example, a settable item “duplex” of the MFP 10 and parameters “Bind Long Edge (long_edge), Bind Short Edge (short_edge), Not applicable (off)” settable to this item. The image-forming-apparatus management unit 201 registers such information included in the received response in a settable item table 220 stored in the storage device 24 (Step 1.1.3).

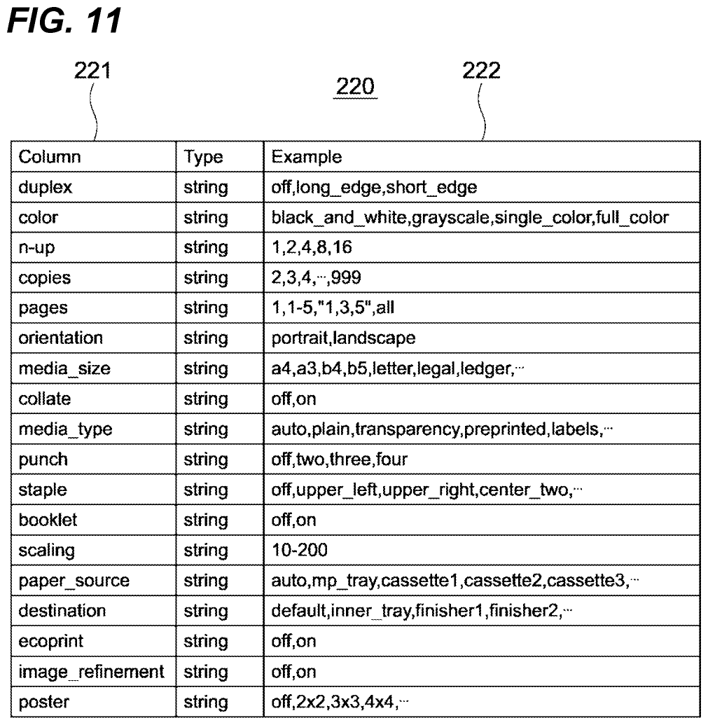

FIG. 11 illustrates an exemplary data configuration of the settable item table.

The settable item table 220 registers a plurality of combinations of a settable item 221 and one or more parameters 222 settable to this item with being associated with one another for one MFP 10.

The image-forming-apparatus management unit 201 of the chatbot device 20, after completing the registration in the printer table 210 and the registration in the settable item table 220, creates a registration completion message that indicates the completion of the registration of the MFP 10, thus posting the registration completion message to the chat system (Step 1.1.4). An exemplary “registration completion message” is “Printer has been added. (e-mail address).”

The image-forming-apparatus registration unit 301 of the server device 30 receives the registration completion message posted from the chatbot device 20 via the network N. The image-forming-apparatus registration unit 301 uploads the posted registration completion message to the chat system. This displays the posting of the registration completion message uploaded to the chat system on the terminal device 40 (C102 in FIG. 8 and C202 in FIG. 9).

The user browses the chat system using the terminal device 40 to post the MFP 10 that executes printing (will execute printing now or will possibly execute printing in the future) to the chat system via the network N. Specifically, the user posts the MFP identification information as the identification information of the MFP 10 to a specific channel of the chat system using the terminal device 40. A concrete example of “the identification information of the MFP 10” may be the e-mail address of the MFP 10.

(2) File Upload Behavior Sequence

The user browses the chat system using the terminal device 40 to post the file as the print target (will be printed now or will be possibly printed in the future) to the chat system via the network N. Specifically, the user posts the file to a specific channel of the chat system using the terminal device 40. A concrete example of “the file” is, for example, a document file, an image file, and a spreadsheet file.

The file posting unit 302 of the server device 30 receives the file posted from the terminal device 40 via the network N (Step 2). The image-forming-apparatus registration unit 301 uploads the posted file to the chat system (Step 2.1). This displays the posting of the file uploaded to the chat system on the terminal device 40.

The above-described (1) MFP registration behavior and (2) file upload behavior may be continuous or discontinuous with behaviors from (3) printing start behavior described below. In other words, insofar as (1) MFP registration behavior and (2) file upload behavior are performed before (3) printing start behavior, its timing may be any time. Any of (1) MFP registration behavior and (2) file upload behavior may be executed in first. The terminal device 40 and the MFP 10 in (1) MFP registration behavior and (2) file upload behavior may be all identical to the terminal device 40 and the MFP 10 in the behaviors from (3) printing start behavior or may be partially or all different devices. However, in the description and the drawings, a description will be given without distinguishing being identical from being different.

(3) Printing Start Behavior Sequence

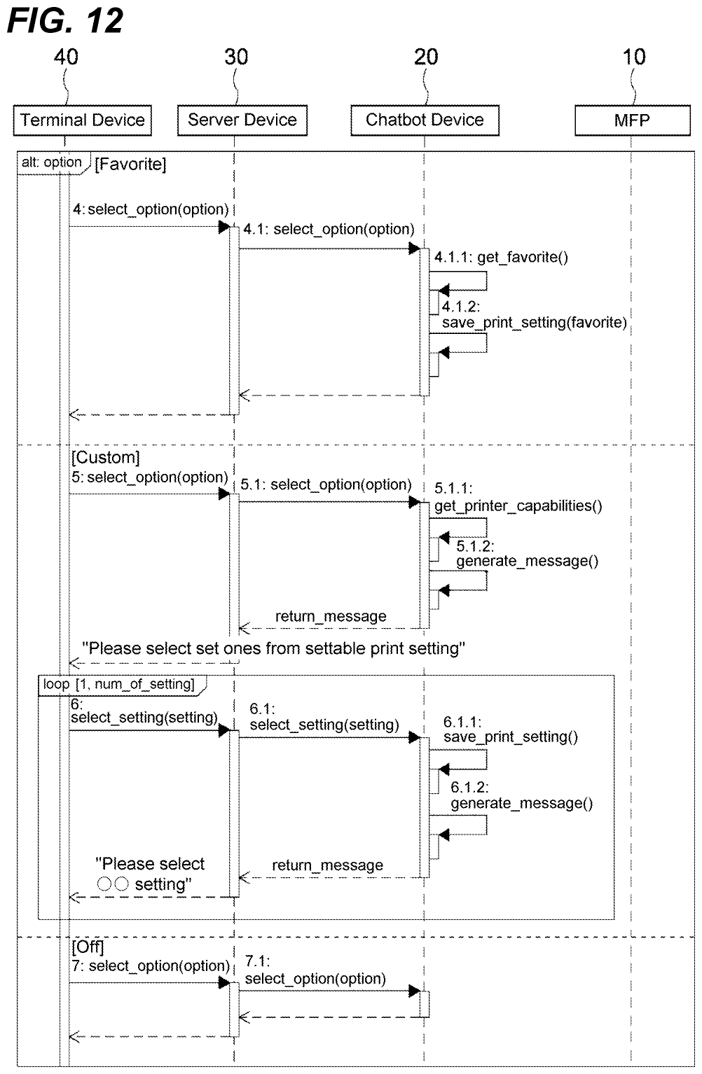

FIG. 12 illustrates a second behavior sequence of the printing assistant system.

The user browses chat of the channel of the MFP 10 that executes printing (will execute printing now) of the chat system using the terminal device 40. The user selects the file as the print target (will be printed now) among the files uploaded to the chat system with, for example, tap operation. This causes the user to post file identification information (for example, file name) of the file as the print target to the channel of the MFP 10 using the terminal device 40. The user may include a specific settable item and/or the parameter to the specific settable item in the posting.

The file transferring unit 303 of the server device 30 receives the file identification information (file name) of the file selected from the terminal device 40 via the network N (Step 3). The file transferring unit 303 uploads the posted file identification information (file name) to the chat system. This displays the posting of the file identification information (file name) uploaded to the chat system (C103 in FIG. 8) on the terminal device 40. Alternatively, the posting including the file identification information (file name) and the specific settable item and/or the parameter to the specific settable item (C203 in FIG. 9) is displayed on the terminal device 40. The file transferring unit 303 transfers the MFP identification information specified with the channel and the file identification information of the file as the print target to the chatbot device 20 via the network N.

The file obtainer 202 of the chatbot device 20 receives the file as the print target, the MFP identification information that identifies the MFP 10 that prints the file, and the specific settable item and/or the parameter to the specific settable item (only when being posted) from the server device 30 via the network N (Step 3.1). The file obtainer 202 stores the received file as the print target in a file storage region 230 of the storage device 24 (Step 3.1.1).

Hereinafter, a description will be given by being divided into (A) a case where the file obtainer 202 of the chatbot device 20 has not received the specific settable item and/or the parameter to the specific settable item (C103 in FIG. 8) and (B) a case where the file obtainer 202 of the chatbot device 20 has received the specific settable item and/or the parameter to the specific settable item (C203 in FIG. 9) in Step 3.1.

(A) Case where the Specific Settable Item and/or the Parameter to the Specific Settable Item has not been Received (C103 in FIG. 8)

The print setting posting unit 203 of the chatbot device 20 reads out the settable item table 220 of the MFP 10 identified with the received MFP identification information from the storage device 24 (Step 3.1.2). The print setting posting unit 203 searches a favorite table 240 with respect to the MFP 10 identified with the received MFP identification information from the storage device 24. The favorite table 240 with respect to the MFP 10 is possibly registered from the terminal device 40 and the server device 30 or not registered in sometimes.

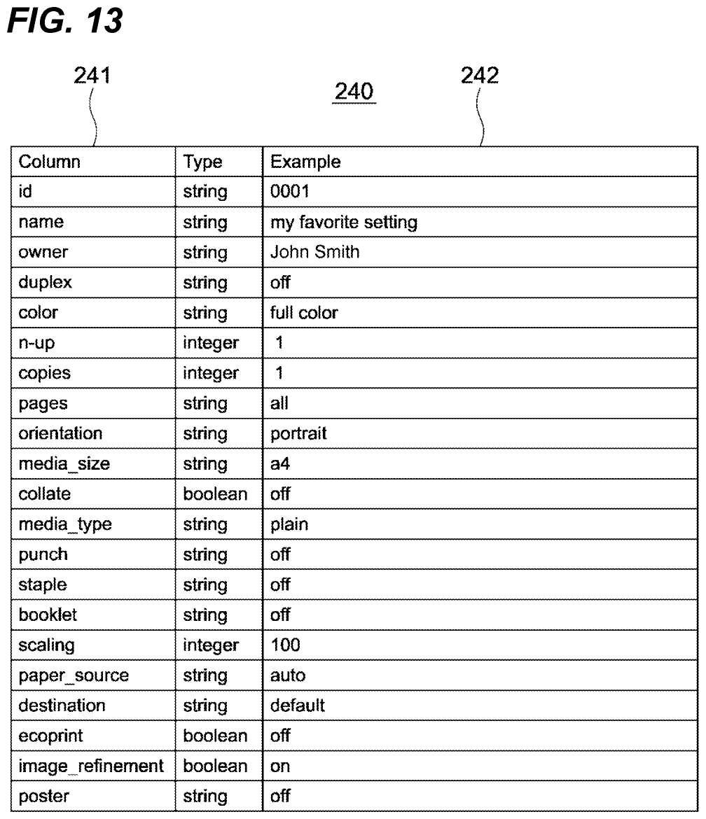

FIG. 13 illustrates an exemplary data configuration of the favorite table.

The favorite table 240 registers a settable item 241 and a parameter 242 set to this item with being associated with one another for one MFP 10.

The print setting posting unit 203 of the chatbot device 20 creates a question message that inquiries about the print setting selected from “favorite, custom, off” to post the question message to the server device 30 when the favorite table 240 with respect to the MFP 10 is registered in the storage device 24 (Step 3.1.3).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C104 in FIG. 8).

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 4, Step 5, and Step 7). The printing chat management unit 304 uploads the posted answer message to the chat system. This displays the posting of the answer message uploaded to the chat system on the terminal device 40 (C105 in FIG. 8). The printing chat management unit 304 transfers the answer message to the chatbot device 20 via the network N.

Hereinafter, a description will be given by being divided into (a) a case where “favorite” is selected (Step 4), (b) a case where “custom” is selected (Step 5), and (c) a case where “off” is selected (Step 7).

(a) Case where “Favorite” is Selected (Step 4)

The print setting posting unit 203 of the chatbot device 20 receives the answer message indicating that “favorite” is selected from the server device 30 via the network N (Step 4.1). The print setting posting unit 203 reads out the favorite table 240 with respect to the MFP 10 identified with the received (Step 3.1) MFP identification information from the storage device 24 (Step 4.1.1). The print setting posting unit 203 saves the parameter 242 set to the settable item 241, which is registered in the favorite table 240, as print setting information 250 when the printing is actually executed, in the storage device 24. The print setting posting unit 203 describes the saved print setting information 250 (settable item and parameter) to create a question message that confirms with the user whether this parameter (that is, the parameter registered in the favorite table 240) is proper, thus posting the question message to the server device 30 (Step 4.1.2).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40.

The user browses the question message posted to the chat system using the terminal device 40 to post an answer message indicating an answer to it to the chat system via the network N.

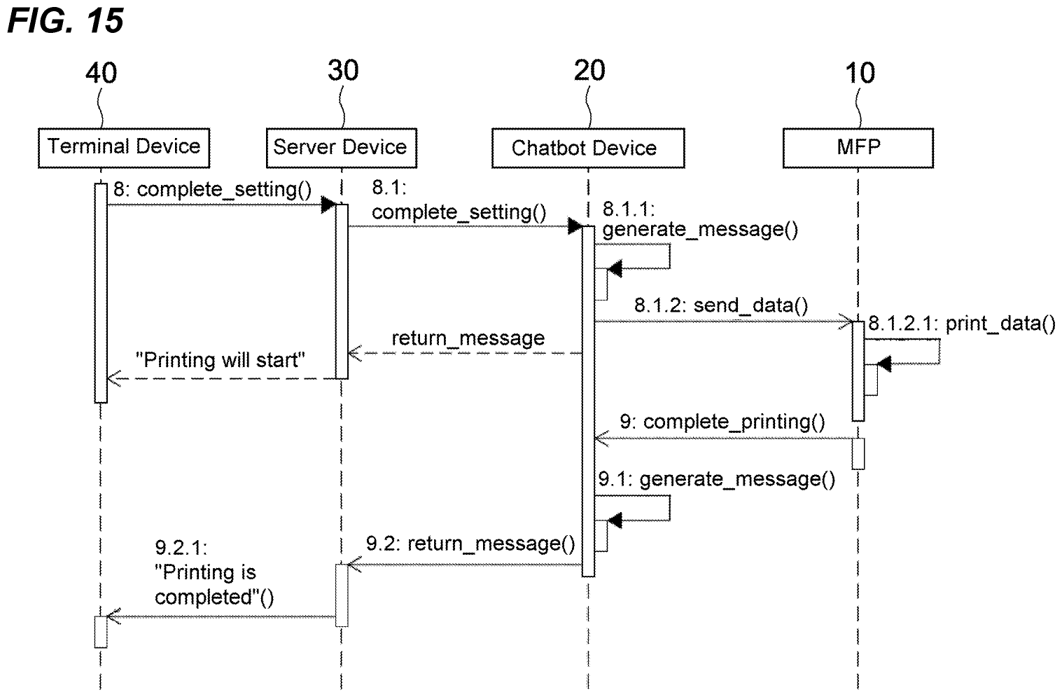

The printing chat management unit 304 of the server device 30 receives the answer message posted from the terminal device 40 via the network N (Step 8 in FIG. 15). The printing chat management unit 304 uploads the posted answer message to the chat system. This displays the posting of the answer message uploaded to the chat system on the terminal device 40. The printing chat management unit 304 transfers the answer message to the chatbot device 20 via the network N. In this example, the answer message indicates that the print setting as the parameter (that is, the parameter registered in the favorite table 240) described in the question message is proper.

The print setting posting unit 203 of the chatbot device 20 receives the answer message indicating that the print setting as the parameter registered in the favorite table 240 is proper from the server device 30 via the network N (Step 8.1 in FIG. 15).

(b) Case where “Custom” is Selected (Step 5)

The print setting posting unit 203 of the chatbot device 20 receives the answer message indicating that “custom” is selected from the server device 30 via the network N (Step 5.1). The print setting posting unit 203 reads out the settable item table 220 with respect to the MFP 10 identified with the received (Step 3.1) MFP identification information from the storage device 24 (Step 5.1.1). The print setting posting unit 203 creates a question message that describes the settable item 221, which is registered in the settable item table 220, to post the question message to the server device 30 (Step 5.1.2). “The question message” is, for example, a message that prompts the user to select a setting item from partially main settable items 221 (alternatively, it may be all the settable items 221) among all the settable items 221 of the MFP 10.

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C106 in FIG. 8).

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 6). The printing chat management unit 304 uploads the posted answer message to the chat system. This displays the posting of the answer message uploaded to the chat system on the terminal device 40 (C107 in FIG. 8). The printing chat management unit 304 transfers the answer message to the chatbot device 20 via the network N. In this example, the answer message indicates that custom setting is performed on three settable items “1. Duplex,” “3. N-up,” and “9. More” (that is, a settable item other than the settable items 1 to 8).

The print setting posting unit 203 of the chatbot device 20 receives the answer message indicating that the custom setting is performed on “1. Duplex,” “3. N-up,” and “9. More” from the server device 30 via the network N (Step 6.1). The print setting posting unit 203 saves these three settable items in the print setting information 250 of the storage device 24. The print setting posting unit 203 creates a question message that inquires of the user of the terminal device 40 about the parameter to be set to the first settable item “1. Duplex” among the three settable items saved in the print setting information 250, thus posting the question message to the server device 30 (Step 6.1.2).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C108 in FIG. 8). In this example, the question message inquires of the user of the terminal device 40 about the parameter to be set to the first settable item “1. Duplex.”

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 6). The printing chat management unit 304 uploads the posted answer message to the chat system. This displays the posting of the answer message uploaded to the chat system on the terminal device 40 (C109 in FIG. 8). The printing chat management unit 304 transfers the answer message to the chatbot device 20 via the network N. In this example, the answer message identifies a parameter “1. Bind Long Edge” to be set to the settable item “1. Duplex.”

The print setting posting unit 203 of the chatbot device 20 receives the answer message indicating that the parameter “1. Bind Long Edge” to be set to the settable item “1. Duplex” is identified, from the server device 30 via the network N (Step 6.1). The print setting posting unit 203 saves the parameter “1. Bind Long Edge” to be set to the settable item “1. Duplex” in the print setting information 250 of the storage device 24. The print setting posting unit 203 creates a question message that inquires of the user of the terminal device 40 about the parameter to be set to the second settable item “3. N-up” among the three settable items saved in the print setting information 250, thus posting the question message to the server device 30 (Step 6.1.2).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C110 in FIG. 8). In this example, the question message inquires of the user of the terminal device 40 about the parameter to be set to the second settable item “3. N-up.”

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 6). The printing chat management unit 304 uploads the posted answer message to the chat system. This displays the posting of the answer message uploaded to the chat system on the terminal device 40 (C111 in FIG. 8). The printing chat management unit 304 transfers the answer message to the chatbot device 20 via the network N. In this example, the answer message identifies a parameter “2” to be set to the settable item “3. N-up.”

The print setting posting unit 203 of the chatbot device 20 receives the answer message indicating that the parameter “2” to be set to the settable item “3. N-up” is identified, from the server device 30 via the network N (Step 6.1). The print setting posting unit 203 saves the parameter “2” to be set to “3. N-up” in the print setting information 250 of the storage device 24. The print setting posting unit 203 creates a question message that inquires of the user of the terminal device 40 about the parameter to be set to the third settable item “9. More” (that is, the settable item other than the settable items 1 to 8) among the three settable items saved in the print setting information 250, thus posting the question message to the server device 30 (Step 6.1.2).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C112 in FIG. 8). In this example, the question message inquires of the user of the terminal device 40 about the parameter to be set to the settable item other than the settable items 1 to 8.

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 8 in FIG. 15). The printing chat management unit 304 uploads the posted answer message to the chat system. This displays the posting of the answer message uploaded to the chat system on the terminal device 40 (C113 in FIG. 8). The printing chat management unit 304 transfers the answer message to the chatbot device 20 via the network N. In this example, the answer message indicates “0. End” that ends the setting of the parameter to the settable item.

The print setting posting unit 203 of the chatbot device 20 receives the answer message indicating “0. End” that ends the setting of the parameter to the settable item, from the server device 30 via the network N (Step 8.1 in FIG. 15). The print setting posting unit 203 saves default values as the parameters to the settable items other than the parameter “1. Bind Long Edge” to be set to the settable item “1. Duplex” and the parameter “2” to be set to “3. N-up” in the print setting information 250 of the storage device 24.

As described above, the print setting posting unit 203 of the chatbot device 20 creates the question message that inquires of the user of the terminal device 40 about the parameter to be set to at least one settable item among the plurality of settable items that are the items settable by the MFP 10 as the print setting, thus posting the question message to the server device 30 (Step 6). The printing chat management unit 304 of the server device 30 receives the question message posted by the chatbot device 20 to upload it to the chat system, and receives the answer message identifying the parameter to be set to at least one settable item posted by the terminal device 40 to upload it to the chat system, thus transferring the answer message to the chatbot device 20. The print setting posting unit 203 of the chatbot device 20 receives the answer message from the server device 30 (Step 6.1), and creates a different question message that inquires of the user of the terminal device 40 about the parameter to be set to a different settable item corresponding to the contents of the answer message, thus posting the different question message to the server device 30 (Step 6.1.2). Until the print setting posting unit 203 of the chatbot device 20 receives the plurality of answer messages identifying the parameters to be set to all the plurality of settable items from the server device 30 (Step 6.1), the posting of the plurality of different question messages is repeated (Step 6.1.2). The print setting posting unit 203 of the chatbot device 20 sets the parameters to all the plurality of settable items based on the plurality of answer messages received from the server device 30 (Step 6.1.1).

(c) Case where “Off” is Selected (Step 7)

The print setting posting unit 203 of the chatbot device 20 receives an answer message indicating that “off” is selected, from the server device 30 via the network N (Step 7.1). The print setting posting unit 203 saves the default parameter 222 (for example, the beginning parameter 222) to the settable item 221, which is registered in the settable item table 220, as the print setting information 250 when the printing is actually executed, in the storage device 24.

(B) Case where the Specific Settable Item and/or the Parameter to the Specific Settable Item has been Received (C203 in FIG. 9)

As described above, the file obtainer 202 of the chatbot device 20 receives the file as the print target, the MFP identification information that identifies the MFP 10 that prints the file, and the specific settable item and/or the parameter to the specific settable item (only when being posted) from the server device 30 via the network N (Step 3.1). In this example, the file obtainer 202 receives the settable item “duplex,” the parameter “10 units” to the settable item “printing copies,” and the parameter “black and white” to the settable item “color” as the specific settable item and/or the parameter to the specific settable item.

The print setting posting unit 203 of the chatbot device 20 reads out the settable item table 220 of the MFP 10 identified with the received MFP identification information from the storage device 24 (Step 3.1.2). The print setting posting unit 203 creates a question message that inquires of the user of the terminal device 40 about the parameter to be set to the settable item “duplex,” thus posting the question message to the server device 30 (Step 3.1.3).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C204 in FIG. 9). In this example, the question message inquires of the user of the terminal device 40 about the parameter to be set to the settable item “duplex.”

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 6). The printing chat management unit 304 uploads the posted answer message to the chat system. This displays the posting of the answer message uploaded to the chat system on the terminal device 40 (C205 in FIG. 9). The printing chat management unit 304 transfers the answer message to the chatbot device 20 via the network N. In this example, the answer message identifies the parameter “2. Bind Short Edge” to be set to the settable item “duplex.”

The print setting posting unit 203 of the chatbot device 20 receives the answer message indicating that the parameter “2. Bind Short Edge” to be set to the settable item “duplex” is identified, from the server device 30 via the network N (Step 6.1). The print setting posting unit 203 saves the parameter “2. Bind Short Edge” to be set to the settable item “duplex” in the print setting information 250 of the storage device 24.

The print setting posting unit 203 of the chatbot device 20 interprets the received (Step 3.1) parameter “10 units” and parameter “black and white” with reference to a dictionary table 260 stored in the storage device 24.

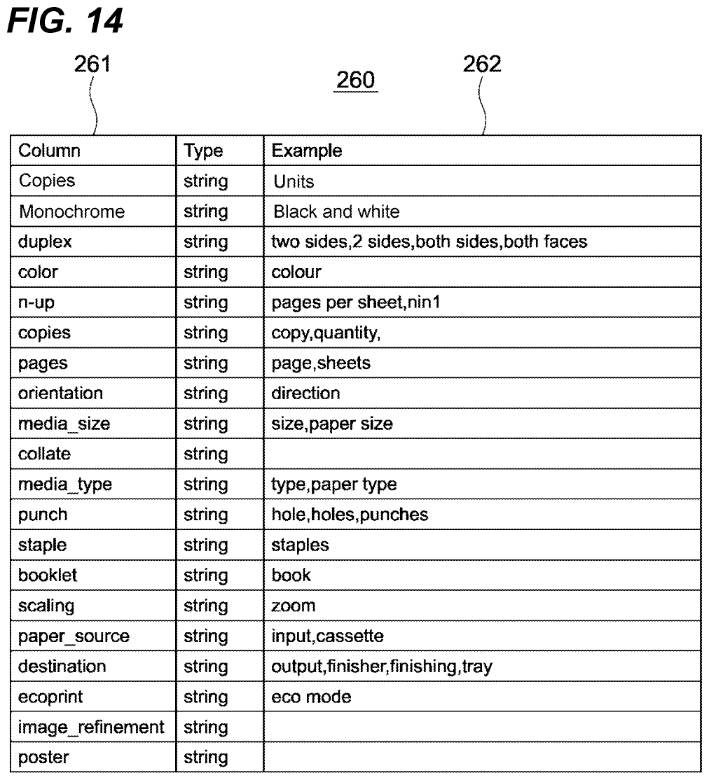

FIG. 14 illustrates an exemplary data configuration of a dictionary table.

The dictionary table 260 registers a varied phrase 262, which is synonymous with an interpretable phrase 261 but uninterpretable by the MFP 10, associated with the interpretable phrase 261 interpretable by the MFP 10. For example, the dictionary table 260 registers the varied phrase 262 “units,” which is synonymous with “copies” but uninterpretable by the MFP 10, associated with the interpretable phrase 261 “copies.” For example, the dictionary table 260 registers the varied phrase 262 “black and white,” which is synonymous with “monochrome” but uninterpretable by the MFP 10, associated with the interpretable phrase 261 “monochrome.”

The print setting posting unit 203 of the chatbot device 20 reads out the interpretable phrase 261 “copies” registered associated with the varied phrase 262 “units” included in “10 units” received (Step 3.1) as the parameter, from the dictionary table 260. The print setting posting unit 203 reads out the interpretable phrase 261 “monochrome” registered associated with the varied phrase 262 “black and white” received (Step 3.1) as the parameter, from the dictionary table 260. Thus, the print setting posting unit 203 interprets the variations (“units” and “black and white”) in the answer message to generate phrases (“copies” and “monochrome”) interpretable by the MFP 10. Then, the print setting posting unit 203 creates the parameters “10 copies” and “monochrome” interpretable by the MFP 10.

The print setting posting unit 203 of the chatbot device 20 creates a question message that confirms interpretation results (“10 copies” and “monochrome”) of the variations in the answer message with the user of the terminal device 40, thus posting the question message to the server device 30 (Step 6.1.2).

The printing chat management unit 304 of the server device 30 receives the question message posted from the chatbot device 20 via the network N. The printing chat management unit 304 uploads the posted question message to the chat system. This displays the posting of the question message uploaded to the chat system on the terminal device 40 (C206 in FIG. 9). In this example, the question message confirms whether the interpretation results (“copies” and “monochrome”) of the variations (“units” and “black and white”) included in the answer message posted by the user are correct.

The user browses the question message posted to the chat system using the terminal device 40 to post an answer message indicating an answer to it to the chat system via the network N.

The printing chat management unit 304 of the server device 30 receives the answer message posted from the terminal device 40 via the network N (Step 8 in FIG. 15). The printing chat management unit 304 uploads the posted answer message to the chat system. This displays the posting of the answer message uploaded to the chat system on the terminal device 40 (C207 in FIG. 9). The printing chat management unit 304 transfers the answer message to the chatbot device 20 via the network N. In this example, the answer message indicates “kk” (slang of “OK”).

The print setting posting unit 203 of the chatbot device 20 receives the answer message indicating “kk” that determines the parameter to the settable item, from the server device 30 via the network N (Step 8.1 in FIG. 15). The print setting posting unit 203 saves the parameter “10 copies” to be set to the settable item “printing copies” and the parameter “monochrome” to be set to the settable item “color” in the print setting information 250 of the storage device 24. The print setting posting unit 203 saves default values as the parameters to the settable items other than the settable items “duplex,” “printing copies,” and “color” in the print setting information 250 of the storage device 24.

As described above, the print setting posting unit 203 of the chatbot device 20 interprets the variation in the answer message received from the server device 30 to set the parameters interpretable by the MFP 10 to all the plurality of settable items. More specifically, the print setting posting unit 203 of the chatbot device 20 creates the question message that confirms the interpretation result of the variation in the answer message with the user of the terminal device 40, thus posting the question message to the server device 30. The printing chat management unit 304 of the server device 30 receives the question message posted by the chatbot device 20 to upload it to the chat system, and receives the answer message to the confirmation to the interpretation result posted by the terminal device 40 to upload it to the chat system, thus transferring the answer message to the chatbot device 20. The print setting posting unit 203 of the chatbot device 20 receives the answer message from the server device 30, and sets the parameter interpretable by the MFP 10 in accordance with the interpretation result when the answer message indicates that the interpretation result is correct.

(4) Printing Operation Sequence

FIG. 15 illustrates a third behavior sequence of the printing assistant system.

The job execution unit 204 of the chatbot device 20 receives the answer message (Step 8.1 or Step 7.1) to create a printing start message indicating that the printing is started (Step 8.1.1). The job execution unit 204 reads out the file as the print target from the file storage region 230 of the storage device 24. The job execution unit 204 reads out the print setting information 250 from the storage device 24. The job execution unit 204 creates the print job that prints the file as the print target in accordance with the print setting information 250 (that is, the parameters set to all the settable items). The job execution unit 204 transmits the created print job to the MFP 10 via the network N (Step 8.1.2). The job execution unit 204 posts the printing start message created in first to the server device 30 after transmitting the print job.

The printing chat management unit 304 of the server device 30 receives the printing start message posted from the chatbot device 20 via the network N. The printing chat management unit 304 uploads the posted printing start message to the chat system. This displays the posting of the printing start message uploaded to the chat system on the terminal device 40 (C114 in FIG. 8 and C208 in FIG. 9).

The MFP 10 receives the print job from the chatbot device 20 via the network N to print the file (Step 8.1.2.1). The MFP 10, when completing (or failing) the printing, transmits a printing execution result to the chatbot device 20 via the network N.

The job execution unit 204 of the chatbot device 20, when receiving the printing execution result from the MFP 10 via the network N (Step 9), creates a printing execution result message indicating that the printing is completed (or failed) (Step 9.1), thus posting the printing execution result message to the server device 30 (Step 9.2).

The printing chat management unit 304 of the server device 30 receives the printing execution result message posted from the chatbot device 20 via the network N. The printing chat management unit 304 uploads the posted printing execution result message to the chat system (Step 9.2.1). This displays the posting of the printing execution result message uploaded to the chat system on the terminal device 40 (C115 in FIG. 8 and C209 in FIG. 9).

(5) Associated File Recommendation Behavior Sequence (not Illustrated)

The associated file recommendation unit 205 of the chatbot device 20, after the printing is completed, stores the file as the print target and terminal device identification information that identifies the terminal device 40 that has selected the file as the print target with being associated with one another in the associated file table 270 of the storage device 24. The associated file recommendation unit 205 creates a recommendation message that recommends another file selected by another terminal device that has selected the file as the print target in the past to the user of the terminal device 40, thus posting the recommendation message to the server device 30.

The printing chat management unit 304 of the server device 30 receives the recommendation message posted by the chatbot device 20 to upload it to the chat system. This displays the recommendation message that recommends the file, which is uploaded to the chat system, on the terminal device 40. The user can know the recommended file by browsing the chat system using the terminal device 40.

### 8. Conclusion

Typically, when the user browses a print setting screen of a printer driver to input print setting using a terminal device, the user browses a plurality of tab screens in sequence to search a desired settable item, thus selecting a desired parameter from a pull-down menu and the like. At this time, there is a case where the desired settable item does not exist in a tab screen opened with expecting that the desired settable item exists there and thus, the user cannot search a location of the desired settable item as a result. In order to browse all the settable items, it is necessary to browse all the tab screens in sequence. Accordingly, the user possibly fails to select the desired settable item. Thus, the print setting screen of the printer driver is not necessarily convenient for the user.

In contrast, according to the embodiment, the print setting posting unit 203 of the chatbot device 20 posts the question message that questions the parameter to be set to one settable item to the chat system. The user browses the question message posted to the chat system to post the answer message identifying the parameter to the chat system. Its repetition allows the user to set the parameters fully to all the settable items in an extremely intuitively simple method such as sequentially posting the answer messages to the sequentially posted question messages. This spares the user the trouble of searching the desired settable item from the print setting screen of the printer driver and eliminates a possibility of failing to select the desired settable item. Originally, the printer driver needs not to be installed in the terminal device 40.

The answer message input by the user may include the varied phrase uninterpretable by the MFP 10 since the user posts a free answer message to the chat system. However, according to the embodiment, the print setting posting unit 203 of the chatbot device 20 interprets the variation in the answer message to set the parameter interpretable by the MFP 10 to the settable item, thus ensuring accurate execution of a desired print job.

According to the embodiment, the print setting posting unit 203 of the chatbot device 20 posts the question message that confirms the interpretation result of the variation in the answer message with the user of the terminal device 40 to more and more surely set the parameter interpretable by the MFP 10, thus ensuring the accurate execution of the desired print job.

According to the embodiment, the associated file recommendation unit 205 of the chatbot device 20 posts the recommendation message that recommends another file selected by another terminal device that has selected the file as the print target, to the user of the terminal device 40 in a chat format. This allows the user to know the recommended file following the chat in an extremely intuitively simple method.

According to the embodiment, when the answer message posted by the user indicates selection of favorite print setting information, the print setting posting unit 203 of the chatbot device 20 sets a plurality of parameters defined with the favorite print setting information to a plurality of settable items. This causes the chatbot device 20 to manage the favorite print setting information, thus allowing a plurality of users to share the favorite print setting information via the chat system.

According to the embodiment, the image-forming-apparatus management unit 201 of the chatbot device 20 manages a plurality of MFPs 10, thus allowing a plurality of users to share the plurality of MFPs 10 via the chat system. Even if the printer driver is not installed in the terminal device 40 used by an individual user, the plurality of users can share the plurality of MFPs 10 via the chat system.

According to the embodiment, the image-forming-apparatus registration unit 301 of the server device 30 registers the channel different depending on the MFP 10 in the chat system. This allows the user to select the MFP 10 in an extremely intuitively simple method such as selecting the channel in the chat system.

According to the embodiment, the job execution unit 204 of the chatbot device 20 receives the execution result of the print job from the MFP 10 to create the result message indicating the execution result, thus posting the result message to the server device. This allows the user to know the execution result of the print job following the chat in an extremely intuitively simple method.

### Exemplary Embodiment of the Disclosure

A printing assistant system according to one form of the disclosure includes

a server device connected to a network, the server device providing a chat system and including a first control circuit, and

a chatbot device connected to the network, the chatbot device including a second control circuit that automatically posts a message to the chat system.

The first control circuit of the server device operates as
a file posting unit that uploads files posted via the network to the chat system, and
a file transferring unit that transfers a file as a print target among the files uploaded to the chat system and image-forming-apparatus identification information to the chatbot device, the image-forming-apparatus identification information identifying an image forming apparatus that prints the file, the file as the print target being selected from a terminal device via the network, and the image-forming-apparatus identification information being selected from the terminal device via the network.

The second control circuit of the chatbot device operates as
a file obtainer that receives the file and the image-forming-apparatus identification information from the server device, and
a print setting posting unit that creates a question message that inquires of a user of the terminal device about a parameter to be set to one settable item among a plurality of settable items and posts the question message to the server device. The plurality of settable items includes items settable as print setting by the image forming apparatus identified with the image-forming-apparatus identification information.

The first control circuit of the server device operates as
a printing chat management unit that receives the question message posted by the chatbot device to upload the question message to the chat system, receives an answer message identifying the parameter to be set to the one settable item posted by the terminal device to upload the answer message to the chat system, and transfers the uploaded answer message to the chatbot device.

The print setting posting unit of the chatbot device
receives the answer message from the server device, creates a different question message that inquires of the user of the terminal device about a parameter to be set to a different settable item corresponding to contents of the received answer message, and posts the created question message to the server device,
repeats posting of a plurality of different question messages until receiving a plurality of answer messages identifying parameters to be set to all the plurality of settable items from the server device, and
sets parameters to all the plurality of settable items based on the plurality of answer messages received from the server device.

The second control circuit of the chatbot device operates as
a job execution unit that creates a print job that prints the file in accordance with the parameters set to all the plurality of settable items and transmits the print job to the image forming apparatus via the network.

According to the form, the print setting posting unit of the chatbot device posts the question message that questions the parameter to be set to one settable item to the chat system. The user browses the question message posted to the chat system to post the answer message identifying the parameter to the chat system. Its repetition allows the user to set the parameters fully to all the settable items in an extremely intuitively simple method such as sequentially posting the answer messages to the sequentially posted question messages.

The print setting posting unit of the chatbot device interprets a variation in the answer message received from the server device and sets parameters interpretable by the image forming apparatus to all the plurality of settable items.

The answer message input by the user may include the varied phrase uninterpretable by the image forming apparatus since the user posts a free answer message to the chat system. However, according to the form, the print setting posting unit of the chatbot device interprets the variation in the answer message to set the parameter interpretable by the image forming apparatus to the settable item, thus ensuring accurate execution of a desired print job.

The print setting posting unit of the chatbot device creates a question message that confirms an interpretation result of the variation in the answer message with the user of the terminal device and posts the question message to the server device.

The printing chat management unit of the server device receives the question message posted by the chatbot device to upload the received question message to the chat system, receives an answer message to the confirmation to the interpretation result posted by the terminal device to upload the answer message to the chat system, and transfers the uploaded answer message to the chatbot device.

The print setting posting unit of the chatbot device receives the transferred answer message from the server device and sets a parameter interpretable by the image forming apparatus in accordance with the interpretation result when the received answer message indicates that the interpretation result is correct.

According to the form, the print setting posting unit of the chatbot device posts the question message that confirms the interpretation result of the variation in the answer message with the user of the terminal device to more and more surely set the parameter interpretable by the image forming apparatus, thus ensuring the accurate execution of the desired print job.

The second control circuit of the chatbot device
associates the file as the print target with terminal device identification information that identifies the terminal device that has selected the file as the print target, and stores the file as the print target and the terminal device identification information, and
operates as an associated file recommendation unit that creates a recommendation message that recommends another file to the user of the terminal device and posts the recommendation message to the server device. The other file is selected by another terminal device that has selected the file as the print target.

The printing chat management unit of the server device receives the recommendation message posted by the chatbot device and uploads the received recommendation message to the chat system.

According to the form, the associated file recommendation unit of the chatbot device posts the recommendation message that recommends another file selected by another terminal device that has selected the file as the print target to the user of the terminal device in a chat format. This allows the user to know the recommended file following the chat in an extremely intuitively simple method.

The print setting posting unit of the chatbot device receives the answer message from the server device, and when the answer message indicates selection of favorite print setting information that defines a plurality of parameters to be set to a plurality of settable items, the print setting posting unit sets the plurality of parameters defined with the favorite print setting information to the plurality of settable items.

According to the form, when the answer message posted by the user indicates selection of favorite print setting information, the print setting posting unit of the chatbot device sets a plurality of parameters defined with the favorite print setting information to a plurality of settable items. This causes the chatbot device to manage the favorite print setting information, thus allowing a plurality of users to share the favorite print setting information via the chat system.

The first control circuit of the server device
operates as an image-forming-apparatus registration unit that registers the image-forming-apparatus identification information posted via the network in the chat system and transfers the image-forming-apparatus identification information to the chatbot device.

The second control circuit of the chatbot device
operates as an image-forming-apparatus management unit that inquires of the image forming apparatus via the network about the plurality of settable items and a plurality of settable parameters of the image forming apparatus identified with the image-forming-apparatus identification information received from the server device and manages the plurality of settable items and the plurality of settable parameters obtained from the image forming apparatus.

According to the form, the image-forming-apparatus management unit of the chatbot device manages a plurality of image forming apparatuses, thus allowing a plurality of users to share the plurality of image forming apparatuses via the chat system. Even if the printer driver is not installed in the terminal device used by an individual user, the plurality of users can share the plurality of image forming apparatuses via the chat system.

The image-forming-apparatus registration unit of the server device registers a channel different depending on the image forming apparatus identified with the image-forming-apparatus identification information posted via the network in the chat system.

According to the form, the image-forming-apparatus registration unit of the server device registers the channel different depending on the image forming apparatus in the chat system. This allows the user to select the image forming apparatus in an extremely intuitively simple method such as selecting the channel in the chat system.

The job execution unit of the chatbot device
receives an execution result of the print job from the image forming apparatus, creates a result message that indicates the execution result, and posts the result message to the server device.

The printing chat management unit of the server device receives the result message posted by the chatbot device and uploads the result message to the chat system.

According to the form, the job execution unit of the chatbot device receives the execution result of the print job from the image forming apparatus to create the result message indicating the execution result, thus posting the result message to the server device. This allows the user to know the execution result of the print job following the chat in an extremely intuitively simple method.

A chatbot device according to one form of the disclosure is a chatbot device of a printing assistant system including:

a server device connected to a network, the server device providing a chat system and including a first control circuit, and

a chatbot device connected to the network, the chatbot device including a second control circuit that automatically posts a message to the chat system.

The first control circuit of the server device operates as
a file posting unit that uploads files posted via the network to the chat system, and
a file transferring unit that transfers a file as a print target among the files uploaded to the chat system and image-forming-apparatus identification information to the chatbot device, the image-forming-apparatus identification information identifying an image forming apparatus that prints the file, the file as the print target being selected from a terminal device via the network, and the image-forming-apparatus identification information being selected from the terminal device via the network.

The second control circuit of the chatbot device operates as
a file obtainer that receives the file and the image-forming-apparatus identification information from the server device, and
a print setting posting unit that creates a question message that inquires of a user of the terminal device about a parameter to be set to one settable item among a plurality of settable items and posts the question message to the server device. The plurality of settable items includes items settable as print setting by the image forming apparatus identified with the image-forming-apparatus identification information.

The first control circuit of the server device operates as
a printing chat management unit that receives the question message posted by the chatbot device to upload the question message to the chat system, receives an answer message identifying the parameter to be set to the one settable item posted by the terminal device to upload the answer message to the chat system, and transfers the uploaded answer message to the chatbot device.

The print setting posting unit of the chatbot device
receives the answer message from the server device, creates a different question message that inquires of the user of the terminal device about a parameter to be set to a different settable item corresponding to contents of the received answer message, and posts the created question message to the server device,
repeats posting of a plurality of different question messages until receiving a plurality of answer messages identifying parameters to be set to all the plurality of settable items from the server device, and
sets parameters to all the plurality of settable items based on the plurality of answer messages received from the server device.

The second control circuit of the chatbot device operates as
a job execution unit that creates a print job that prints the file in accordance with the parameters set to all the plurality of settable items and transmits the print job to the image forming apparatus via the network.

### Effect of the Disclosure

The disclosure ensures automatic posting of the message for needs of an individual user in the technique of the chatbot.

The effects described here are not necessarily limited and may be any of the effects described in the disclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A printing assistant system comprising:
a server device connected to a network, the server device providing a chat system and including a first control circuit; and
a chatbot device connected to the network, the chatbot device including a second control circuit that automatically posts a message to the chat system,
wherein the first control circuit of the server device operates as:
a file posting unit that uploads files posted via the network to the chat system; and
a file transferring unit that transfers a file as a print target among the files uploaded to the chat system and image-forming-apparatus identification information to the chatbot device, the image-forming-apparatus identification information identifying an image forming apparatus that prints the file, the file as the print target being selected from a terminal device via the network, and the image-forming-apparatus identification information being selected from the terminal device via the network,
the second control circuit of the chatbot device operates as:
a file obtainer that receives the file and the image-form ing-apparatus identification information from the server device; and
a print setting posting unit that creates a question message that inquires of a user of the terminal device about a parameter to be set to one settable item among a plurality of settable items and posts the question message to the server device, the plurality of settable items including items settable as print setting by the image forming apparatus identified with the image-forming-apparatus identification information,
the first control circuit of the server device operates as
a printing chat management unit that receives the question message posted by the chatbot device to upload the question message to the chat system, receives an answer message identifying the parameter to be set to the one settable item posted by the terminal device to upload the answer message to the chat system, and transfers the uploaded answer message to the chatbot device,
the print setting posting unit of the chatbot device:
receives the answer message from the server device, creates a different question message that inquires of the user of the terminal device about a parameter to be set to a different settable item corresponding to contents of the received answer message, and posts the created question message to the server device,
repeats posting of a plurality of different question messages until receiving a plurality of answer messages identifying parameters to be set to all the plurality of settable items from the server device, and
sets parameters to all the plurality of settable items based on the plurality of answer messages received from the server device, and
the second control circuit of the chatbot device operates as
a job execution unit that creates a print job that prints the file in accordance with the parameters set to all the plurality of settable items and transmits the print job to the image forming apparatus via the network.

2. The printing assistant system according to claim 1,
wherein the print setting posting unit of the chatbot device interprets a variation in the answer message received from the server device and sets parameters interpretable by the image forming apparatus to all the plurality of settable items.

3. The printing assistant system according to claim 2,
wherein the print setting posting unit of the chatbot device creates a question message that confirms an interpretation result of the variation in the answer message with the user of the terminal device and posts the question message to the server device,
the printing chat management unit of the server device receives the question message posted by the chatbot device to upload the received question message to the chat system, receives an answer message to the confirmation to the interpretation result posted by the terminal device to upload the answer message to the chat system, and transfers the uploaded answer message to the chatbot device, and
the print setting posting unit of the chatbot device receives the transferred answer message from the server device and sets a parameter interpretable by the image forming apparatus in accordance with the interpretation result when the received answer message indicates that the interpretation result is correct.

4. The printing assistant system according to claim 1,
wherein the second control circuit of the chatbot device:
associates the file as the print target with terminal device identification information that identifies the terminal device that has selected the file as the print target, and stores the file as the print target and the terminal device identification information, and
operates as an associated file recommendation unit that creates a recommendation message that recommends another file to the user of the terminal device and posts the recommendation message to the server device, the other file being selected by another terminal device that has selected the file as the print target, and
the printing chat management unit of the server device receives the recommendation message posted by the chatbot device and uploads the received recommendation message to the chat system.

5. The printing assistant system according to claim 1,
wherein the print setting posting unit of the chatbot device receives the answer message from the server device, and when the answer message indicates selection of favorite print setting information that defines a plurality of parameters to be set to a plurality of settable items, the print setting posting unit sets the plurality of parameters defined with the favorite print setting information to the plurality of settable items.

6. The printing assistant system according to claim 1,
wherein the first control circuit of the server device
operates as an image-forming-apparatus registration unit that registers the image-forming-apparatus identification information posted via the network in the chat system, and transfers the image-forming-apparatus identification information to the chatbot device, and
the second control circuit of the chatbot device
operates as an image-forming-apparatus management unit that inquires of the image forming apparatus via the network about the plurality of settable items and a plurality of settable parameters of the image forming apparatus identified with the image-forming-apparatus identification information received from the server device, and manages the plurality of settable items and the plurality of settable parameters obtained from the image forming apparatus.

7. The printing assistant system according to claim 6,
wherein the image-forming-apparatus registration unit of the server device registers a channel different depending on the image forming apparatus identified with the image-forming-apparatus identification information posted via the network in the chat system.

8. The printing assistant system according to claim 1,
wherein the job execution unit of the chatbot device
receives an execution result of the print job from the image forming apparatus, creates a result message that indicates the execution result, and posts the result message to the server device, and
the printing chat management unit of the server device receives the result message posted by the chatbot device and uploads the result message to the chat system.

9. A chatbot device of a printing assistant system comprising:
a server device connected to a network, the server device providing a chat system and including a first control circuit; and
a chatbot device connected to the network, the chatbot device including a second control circuit that automatically posts a message to the chat system,
wherein the first control circuit of the server device operates as:
a file posting unit that uploads files posted via the network to the chat system; and
a file transferring unit that transfers a file as a print target among the files uploaded to the chat system and image-forming-apparatus identification information to the chatbot device, the image-forming-apparatus identification information identifying an image forming apparatus that prints the file, the file as the print target being selected from a terminal device via the network, and the image-forming-apparatus identification information being selected from the terminal device via the network,
the second control circuit of the chatbot device operates as:
a file obtainer that receives the file and the image-form ing-apparatus identification information from the server device; and
a print setting posting unit that creates a question message that inquires of a user of the terminal device about a parameter to be set to one settable item among a plurality of settable items and posts the question message to the server device, the plurality of settable items including items settable as print setting by the image forming apparatus identified with the image-forming-apparatus identification information,
the first control circuit of the server device operates as
a printing chat management unit that receives the question message posted by the chatbot device to upload the question message to the chat system, receives an answer message identifying the parameter to be set to the one settable item posted by the terminal device to upload the answer message to the chat system, and transfers the uploaded answer message to the chatbot device,
the print setting posting unit of the chatbot device:
receives the answer message from the server device, creates a different question message that inquires of the user of the terminal device about a parameter to be set to a different settable item corresponding to contents of the received answer message, and posts the created question message to the server device,
repeats posting of a plurality of different question messages until receiving a plurality of answer messages identifying parameters to be set to all the plurality of settable items from the server device, and
sets parameters to all the plurality of settable items based on the plurality of answer messages received from the server device, and
the second control circuit of the chatbot device operates as
a job execution unit that creates a print job that prints the file in accordance with the parameters set to all the plurality of settable items and transmits the print job to the image forming apparatus via the network.
